(19) United States
(12) Patent Application Publication
(10) Pub. No.: US 2003/0177390 A1
(43) Pub. Date: Sep. 18, 2003

(54) Securing applications based on application infrastructure security techniques

(76) Inventor: Rakesh Radhakrishnan, Ashburn, VA (US)

Correspondence Address: HOGAN & HARTSON LLP, ONE TABOR CENTER, SUITE 1500, 1200 SEVENTEEN ST., DENVER, CO, 80202, US

(21) Appl. No.: 10/188,226

(22) Filed: Jul. 2, 2002

Related U.S. Application Data
(60) Provisional application No. 60/364,957, filed on Mar. 15, 2002.

(51) Int. Cl. H04L 9/00

(52) U.S. Cl. 713/201

(57) ABSTRACT

The preferred embodiments relate to a system for providing secure access via a public network for at least one client computer to a local network having a legacy system. The system preferably includes a client computer in communication with a public network, an access service zone operating as a touch point for communication with the client computer, a network identity service zone providing network security techniques for securing communications with the client computer, a first firewall between the access service zone and the network identity service zone, and a second firewall between the network identity service zone and a network application zone. Whereby, secure access to the network application zone can be provided to a user at the client computer. The preferred embodiments also align application infrastructure with application techniques used.

The present application claims priority to U.S. Provisional Application Serial No. 60/364,957 filed on Mar. 15, 2002, entitled Securing J2EE Applications Based On Application Infrastructure Security Techniques, the entire disclosure of which is incorporated herein in its entirety as though recited herein in full.

### FIELD OF THE INVENTION

The present invention relates generally to security techniques used in network environments, such as for example in applications in which users obtain access to a private network via a public network (such as, e.g., over the Internet or the World Wide Web).

### INTRODUCTION

In many network applications, security can be a notable issue where, e.g., what was traditionally offered within closed networks (e.g., local area networks [LAN], wide area networks [WAN], virtual area network [VAN], etc.), such as business services, may be extended and offered via the Internet or other network. To begin with, it is helpful to understand the pervasive nature of security, in terms of: application security (such as, e.g., protection domains within and between applications, application level intrusion detection/deployment descriptors, JAD, etc.); application infrastructure security (such as, e.g., PKI, Certificates, SSL, LDAP, S-Http, etc.); network security (such as, e.g., Firewalls, DMZ, VLAN, VPN, NID, etc.); and compute and storage security (such as, e.g., OS hardening, zoning, etc.).

Attacks can be, e.g., generally characterized as privacy attacks, communication attacks and system attacks. In many cases, security may drive the overall architecture more than any other capability. A highly sensitive financial application, for example, preferably ensures that attacks such as forgery, unauthorized usage and masquerading (e.g., illustrative privacy attacks), spoofing, sniffing and replays (e.g., illustrative communication attacks), viruses, denial of service and deletion of data (e.g., illustrative system attacks) are simply impossible to achieve by a hackers.

A Java™ 2 Platform, Enterprise Edition (J2EE™) technology based application for instance, in illustrative cases, may extend specific functionality offered internally within an enterprise network to the Internet. These applications could include, in some illustrative examples, a customer facing application, an employee portal, a supply chain management application or any other illustrative application or the like. In many cases, however, it may include extending an enterprise's legacy environment to the Internet or into another network, public domain or the like.

The entire deployment of the application infrastructure could be, for example, within an overall DMZ—a zone between the legacy environment and the Internet or the like. DMZ refers to, e.g., a demilitarized zone, such as a computer host or network inserted in a neutral zone between a company's private network and an external public network. In an illustrative DMZ configuration, users of a public network outside a private network can only access a DMZ host computer.

J2EE™ technology, for example, being, more than a programming language, but a technology platform can address security issues via many techniques. One notable characteristic of J2EE™ technology as a programming language is its support of multiple security techniques at the application infrastructure layer, by lending and blending itself with security extensions, such as, for example: Java Cryptography Extensions (JCE); Java Secure Socket Extensions (JSSE); Java Authentication and Authorization Service (JAAS); Java Byte Code Verifier (JBCV); Java Security Manager (JSM); Java Access Control (JAC); Java Application Descriptor (JAD); etc. All of these extensions and security services can directly translate to application infrastructure with built-in security techniques.

Java Cryptography Extensions, for example, can support encryption and decryption of data, messages, code, transactions, etc., right at the origination and destination points. For example, this capability can also offer application level VPN (virtual private network) as opposed to network level VPN (virtual private network)—firewall to firewall or VPN switch to VPN switch.

In addition, other security capabilities of J2EE™ technology include, e.g., support for deployment descriptors in the application platform and the establishment of protection domains within application code. Deployment descriptors can include portable property sheets for EJB™ Components in the form of an XML document stored in LDAP and accessed via JNDI (Java Naming and Directory Interface), which allows for transaction controls for methods and sets up access control lists. Protection domains describe trusted J2EE™ components within an application and between applications. Essentially, stating which JSP™/Servlets can access which EJB™ (Enterprise JavaBean) components, which EJB™ components can access specific data access objects, etc. These techniques (e.g., deployment descriptors) built-in to a J2EE™ application server offer security within the “virtual application layer.” However, many such security techniques offered by other application infrastructure solutions ensure end-to-end security in a J2EE™ environment.

Illustrative embodiments of the present invention can include various techniques that can be adopted to address security for existing architectural environments and can provide, for example, various new designs for basic services such as, for example: e-mail; directory; web; proxy; application; database; transaction; messaging; etc. Business services, such as for instance, an employee portal or an online electronic store, etc., which are built based on Java Technologies such as JSP, Servlets, EJB™ components, etc., can leverage the extensions made to the application infrastructure and act as a more secure application, based on the multi-tiered nature of these application infrastructure.

For example, if an application such as an financial exchange is facing issues and potential loopholes associated with the integrity of transactions, special anomaly checks can be built in through hashing algorithms prior to and after a transaction is packaged and shipped over the network using a messaging platform. If there are concerns about the identity of the users of an application offered over the Internet for an exclusive intelligence community, mutual identity verification techniques offered by a third part certificate system can be augmented with one-time password generation over a application level VPN establishment.

### J2EE Application Infrastructure

A typical J2EE application runs the servlets and JSP components on the web server. Many such components could be cached by the web proxy server. EJB components are served by the application server. SQLJ-or-Java/Stored Procedure (embedded SQL statements in Java) components are running on the database DB servers. Authentication/authorization components are running on an LDAP (Lightweight Directory Access Protocol) server and the J2EE components are signed and certified by the certificate server. If an XML (Extensible Markup Language) based inter application integration is used, then these XML components are run on EAI (enterprise application integration) or B2B (business to business) application integration servers (like Web methods). Using JMS if synchronous transactions are executed by the application, then a messaging server can be used (such as, for example, TIBCO). Similarly, if synchronous application transaction is run, then a transaction server can be used (such as, e.g., TUXEDO). Each application infrastructure vendor extends support to J2EE™ by adhering to its specifications. The basic infrastructure services that make up a typical dot.com environment with their respective J2EE™ technology security components may include, for example, one or more of the following: directory server (e.g., JAAS); proxy server (e.g., JSSE); portal server (e.g., JSSE/JAAS); web server (e.g., JSSE/JCE); application server (e.g., JSM/JAC); messaging server (e.g., JMD/JDS); transaction server (e.g., JMD/JDS); certificate server (e.g., JCE); and/or CORBA server (e.g., CSSS).

In various embodiments, not all dot.com environments are expected to have an implementations of all these basic services. In some embodiments, some or all of the following services, e.g., can be combined: directory server—Java authentication & authorization service; proxy server—protocol tunneling and reverse proxies; mail server—mail proxy and SSL (Secure Socket Layer); web server—web proxy and SSL; application server—protection domains and deployment descriptors; transaction server—streaming transactions over SSL and integrity validation/verification; messaging server—passing of digital certificates and signed/encrypted messages; and/or certificate server—mutual identity verification/validation and digital certificates.

### SUMMARY OF THE PREFERRED EMBODIMENTS

The preferred embodiments of the present invention provide substantial advantages over existing systems and methods.

According to one general illustrative embodiment, a system for providing secure access via a public network for at least one client computer to a local network having a legacy system includes: a) a client computer in communication with a public network; b) an access service zone operating as a touch point for communication with the client computer; c) a network identity service zone providing network security techniques for securing communications with the client computer; d) a first firewall between the access service zone and the network identity service zone; e) a second firewall between the network identity service zone and a network application zone; whereby secure access to the network application zone can be provided to a user at the client computer. Preferably, the access service zone includes at least one server that is configured to communicate only with the network identity service zone and is configured to remain unaware of whether security techniques are to be applied. In some embodiments, the access service zone includes a reverse proxy gateway server or a portal web server. In some embodiments, the network identity service zone provides at least one of the following security techniques: authentication, authorization, virus checking, spam control, intrusion detection, certification/validation of identity. Preferably, the system includes means for aligning application infrastructure with application techniques used within a second tier system.

According to another general illustrative embodiment, a method for creating a secure system providing services from within a private system to at least one client computer via a public network includes: a) establishing a predetermined set of application infrastructure corresponding to application security techniques; b) selecting application security techniques within said set; and c) driving corresponding application infrastructure based on said selected application security techniques in accordance with the established set. In some preferred embodiments, the security techniques include J2EE security techniques. Preferably, the driving corresponding application infrastructure includes deploying a touch point server including a reverse proxy web server, a portal gateway server and/or another server configured to act as a touch point.

Various other embodiments, advantages and/or benefits of various embodiments of the present invention will be appreciated based on the present disclosure. It is contemplated that various embodiments will include and/or exclude different aspects, advantages and/or benefits and that descriptions of aspects, advantages and/or benefits of the various embodiments should not be construed as limiting other embodiments nor the inventions claimed.

### BRIEF DESCRIPTION OF THE DRAWINGS

The attached figures are shown by way of example and not limitation, in which:

FIG. 1 is a schematic flow diagram illustrating a process according to one embodiment;

FIG. 2 is a schematic flow diagram illustrating a concept of derivation according to one embodiment;

FIG. 3 shows an illustrative system providing web and application server deployment;

FIG. 4 shows an illustrative system providing web and application server deployment with a proxy;

FIG. 5 shows an illustrative system providing web and application server deployment with a portal server;

FIG. 6 shows an illustrative system providing web and application server deployment with a portal and proxy server;

FIG. 7 shows an illustrative system providing a simple mail server with a mail proxy;

FIG. 8 shows an illustrative system providing a mail server with a mail proxy;

FIG. 9 shows an illustrative system providing an application server deployed in conjunction with a security server;

FIG. 10 shows an illustrative system providing an application server deployed in conjunction with a security server and an LDAP;

FIG. 11 shows an illustrative system providing an integration server deployed in conjunction without a proxy;

FIG. 12 shows an illustrative system providing an integration server deployed in conjunction with a proxy;

FIG. 13 shows an illustrative system providing integration server deployment;

FIG. 14 shows an illustrative system providing directory server deployment in conjunction with a security server;

FIG. 15 shows an illustrative system providing directory server alternate deployment in conjunction with a security server;

FIG. 16 shows an illustrative logical connection flow for security purposes;

FIG. 17 shows an illustrative system providing secure deployment of messaging server/transaction servers;

FIG. 18 shows an illustrative system providing secure deployment of CORBA servers;

FIG. 19 shows an illustrative system providing secure access to distributed LDAP data;

FIG. 20 shows an illustrative system providing secure deployment of CMS servers; and

FIG. 21 shows an illustrative system providing secure deployment of CMS servers with additional firewall protection.

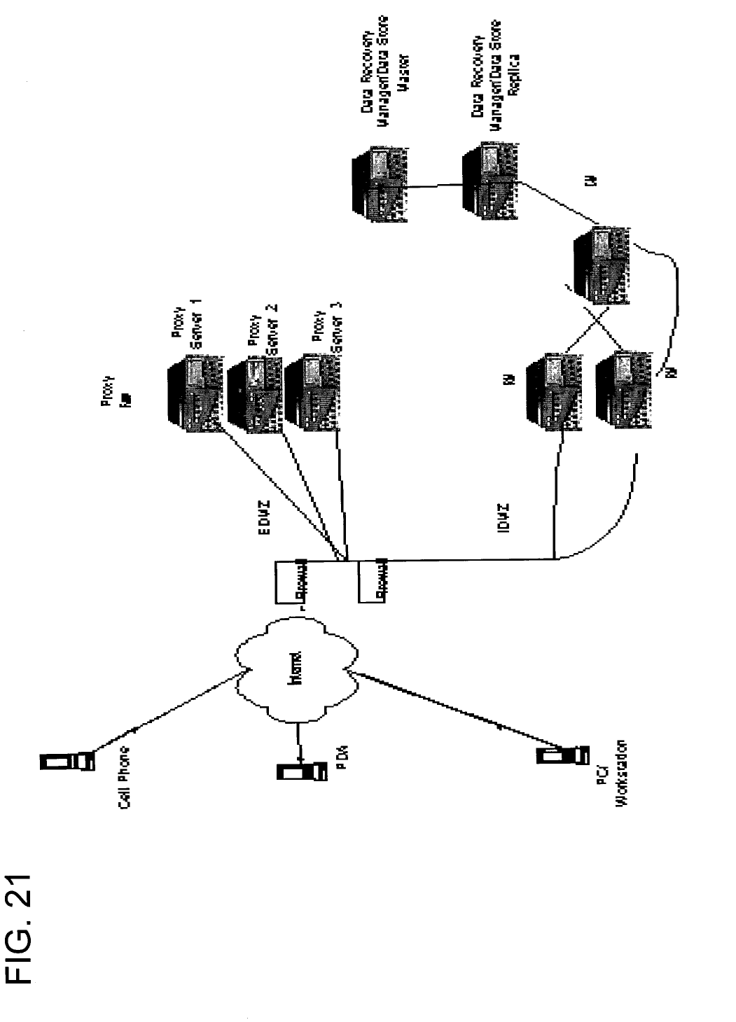

### DETAILED DESCRIPTION OF THE PREFERRED EMBODIMENTS

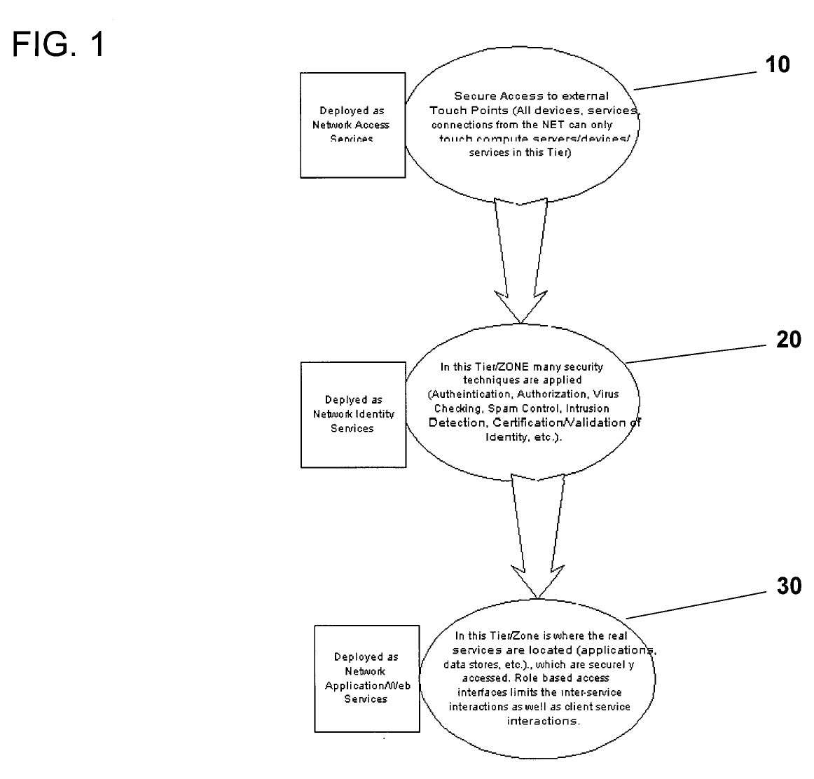

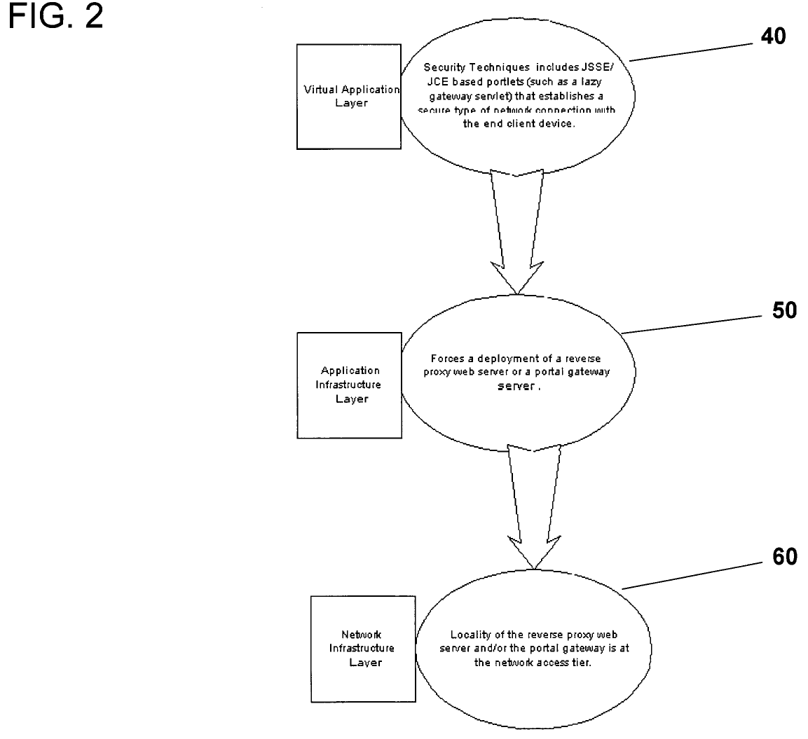

FIG. 1 and 2 illustrate aspects that may be employed in some preferred embodiments of the invention. In various embodiments, application computers, client computers and other computers and/or servers can include any appropriate computers. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. Client computers may contain, in some embodiments, browser software for interacting with the server(s), such as, for example, using hypertext transfer protocol (HTTP) to make requests of the server(s) via the Internet or the like. In some embodiments, client computers may access a secure network via a DMZ between the client computer and, e.g., a legacy system. In some embodiments, an EDMZ (external DMZ), a DMZ and/or an IDMZ (internal DMZ) may be employed.

With reference to FIG. 1, before secure access is provided to internal servers (e.g., at 30), a first tier 10 is employed that provides access and a second tier 20 is employed that provides all of the enforcement of the security rules. Preferably, the first tier 10 operates merely as a touch point. Preferably, the first tier 10 includes a server or the like that can communicate only to a server or the like in the second tier 20. Preferably, the first tier does not even address the idea of whether security techniques are to be applied.

As shown in FIG. 1, the first tier is preferably deployed for network access services, the second tier is preferably deployed for network identity services, and the third tier is preferably deployed for network application/web services. In preferred embodiments, all external devices, computers, systems and the like can only communicate with computers, servers, devices and the like of the first tier 10. Preferably, the first tier operates as a touch point for external clients to communicate with an internal network, such as for example, using the Internet to access a particular network (e.g., a local area network, a wide area network or any other network). In preferred embodiments, the second tier 20 can be used to apply all security techniques, such as, for instance, authentication, authorization, virus checking, spam control, intrusion detection, certification/validation of identity and/or other techniques. In preferred embodiments, the third tier 30 includes all devices, computers, servers and the like where services are located, such as applications, data stores and the like. In the preferred embodiments, role based access interfaces limit the inter-service interactions and the client service interactions. Preferably, a firewall is provided between the first and second tiers, and preferably, another firewall is provided between the second and third tiers.

With respect to FIG. 2, according to another aspect of some preferred embodiments, techniques associated with an application's architecture may be aligned with the application's infrastructure techniques. For instance, within a J2EE space what can be driving JAVA authentication authorization services can drive certain types of application infrastructure deployment. For example, the J2EE related security techniques that can be incorporated within an application can drive the way application infrastructure techniques are used or aligned. The application infrastructure (such as, e.g., a web server, a portal server, a B2Bi server, an application server, a database server, etc.) deployed within a network or the like (such as, e.g., between firewalls, between zones, between segments or the like) is preferably deployed so that the application infrastructure aligns with the techniques used within the application.

In some illustrative embodiments, a predetermined set of application infrastructure with corresponding application techniques can be established, application techniques for a system can be selected and application infrastructure can be selected in accordance with the predetermined set.

With reference to FIG. 2, in step 40 security techniques (such as, e.g., JSSE/JCC based portlets and the like) can be employed to establish secure network connection with an end client computer, device, server or the like. In step 50, the security technique(s) employed force a particular application infrastructure (such as, e.g., a deployment of a reverse proxy web server or a portal gateway server). In step 60, preferably the locality of a reverse proxy web server or a portal gateway server is at the network access tier (such as, e.g., tier 10 shown in FIG. 1).

A number of illustrative implementations demonstrating various embodiments of the invention are discussed in the following sections.

### Web, Portal & Proxy Servers (e.g., JCE & JSSE)

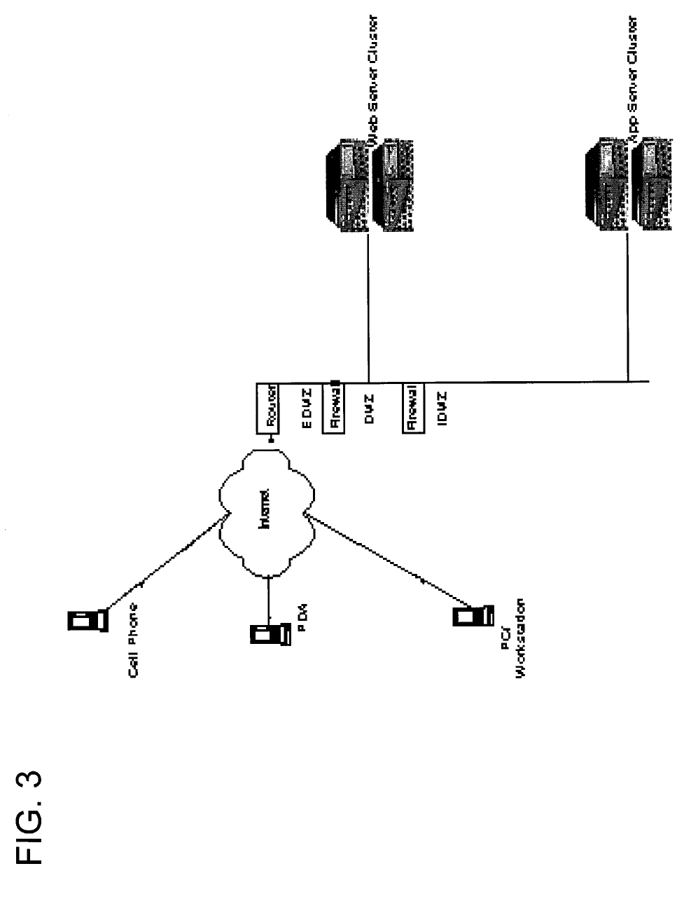

A typical deployment of a J2EE application without severe security requirements in an enterprise can look, for example, like that shown in FIG. 3 which shows an illustrative web and application server deployment.

The application components may be deployed in the application server located in the IDMZ and the web components deployed in the web server located in the EDMZ. This deployment is very applicable for applications where the web components deployed in the web server (JSP/Servlets) are acting more as a gateway, fronting business logic that requires more protection. In certain cases the presentation logic executed by a set of web components may also be deployed in the application servers- in this scenario, if the presentation logic also requires protection.

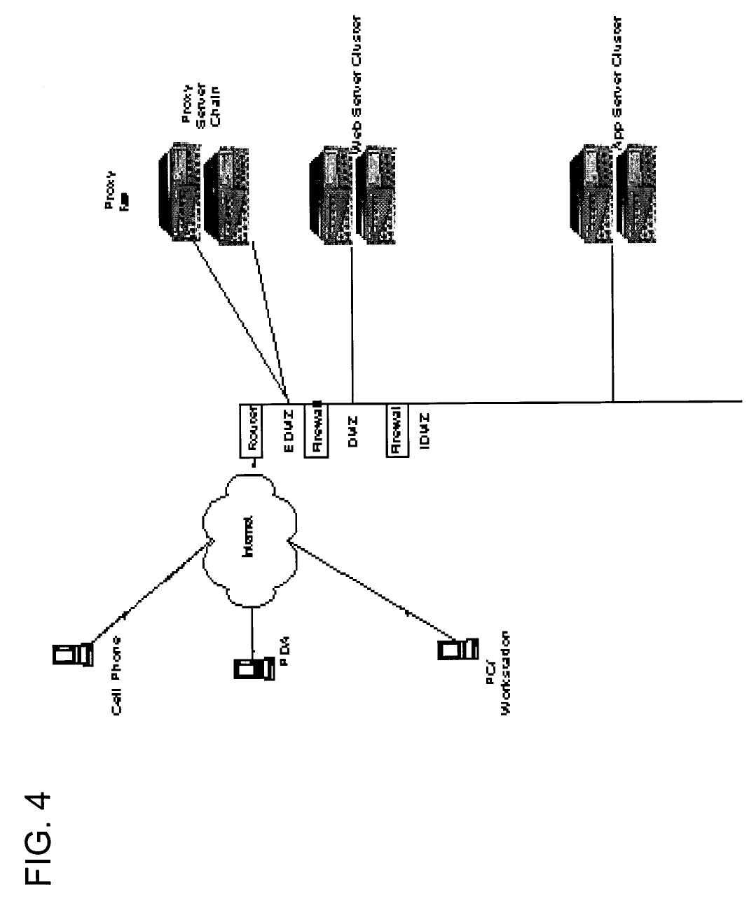

FIG. 4 shows a web and application server deployment with a proxy.

In cases where a J2EE™ application, for example, requires more stringent security, both the web components and the application components can be protected by a web proxy, that accesses the web servers. Preferably, there is no true deployment of any components on the proxy server (e.g., components may be cached) and location transparency is maintained. In this scenario, e.g., where a J2EE application is accessed via a portal server, the deployment may replace the proxy server and combine the web and application components to a web-application server cluster.

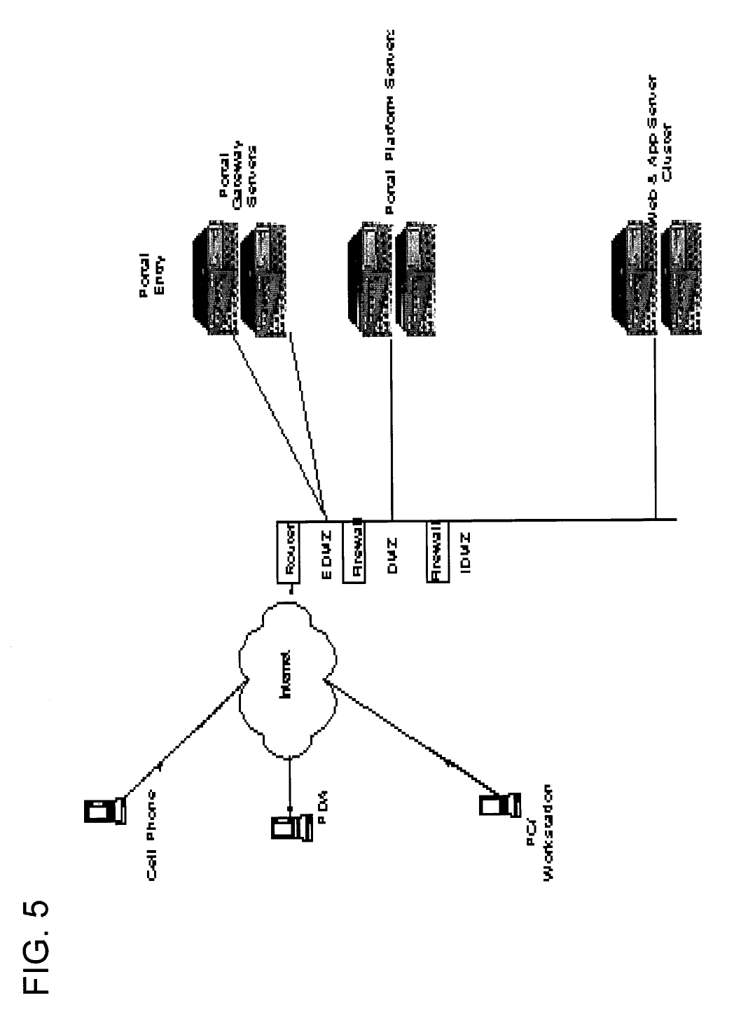

FIG. 5 shows a web and application server deployment with a portal server.

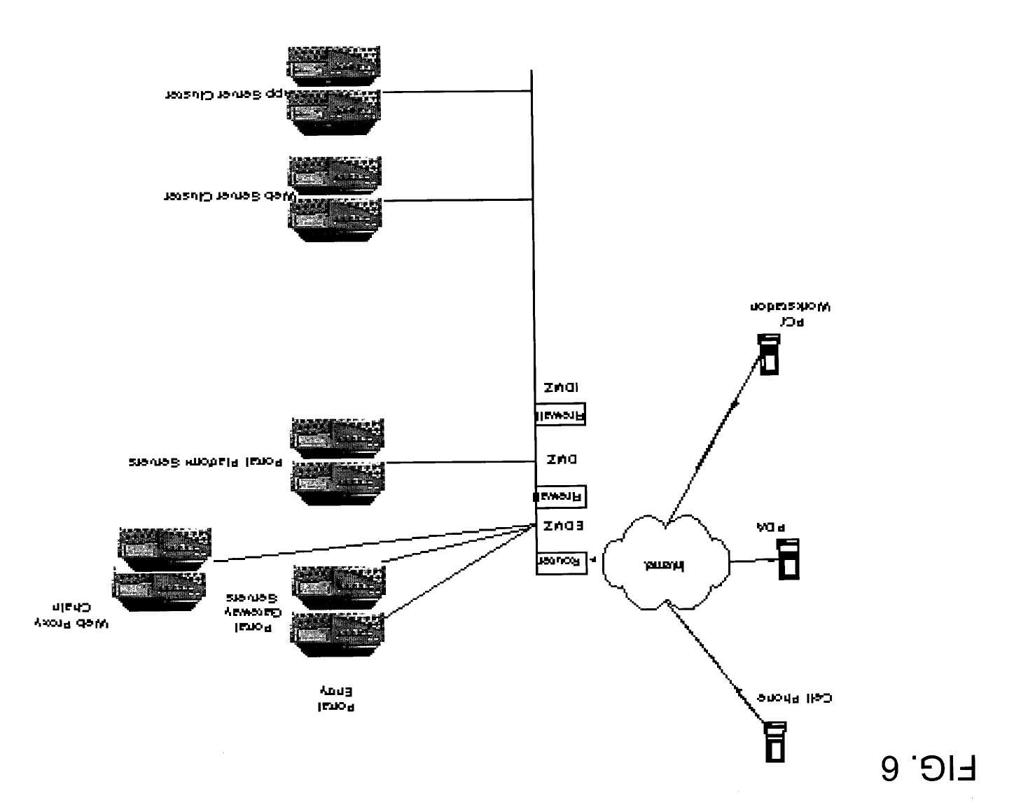

In some embodiments, additional functionality offered by a web proxy server can be replaced with the portal deployment of a portal gateway and a portal platform server. This combination of a portal gateway/platform may provide, e.g., secure access to multiple J2EE™ applications running on multiple web and/or application servers. In certain cases, even with the portal deployment, a web proxy server may be leveraged to offload encryption and/or decryption workload to a dedicated server or servers, as depicted in FIG. 6 which shows a web and application server deployment with portal and proxy server.

### Mail Server—Mail Proxies and Mail Virus Scanning

In, for example, many J2EE™ implementations, the architecture may call for JavaMail™ API usage. This can involve the deployment of a mail server in conjunction with the rest of the application infrastructure solutions. This application infrastructure supporting JavaMail™ API can require addressing security, just as any other application infrastructure. In some embodiments, a simple mail server deployment may involve a mail proxy in the DMZ with a Mail Store in the DMZ.

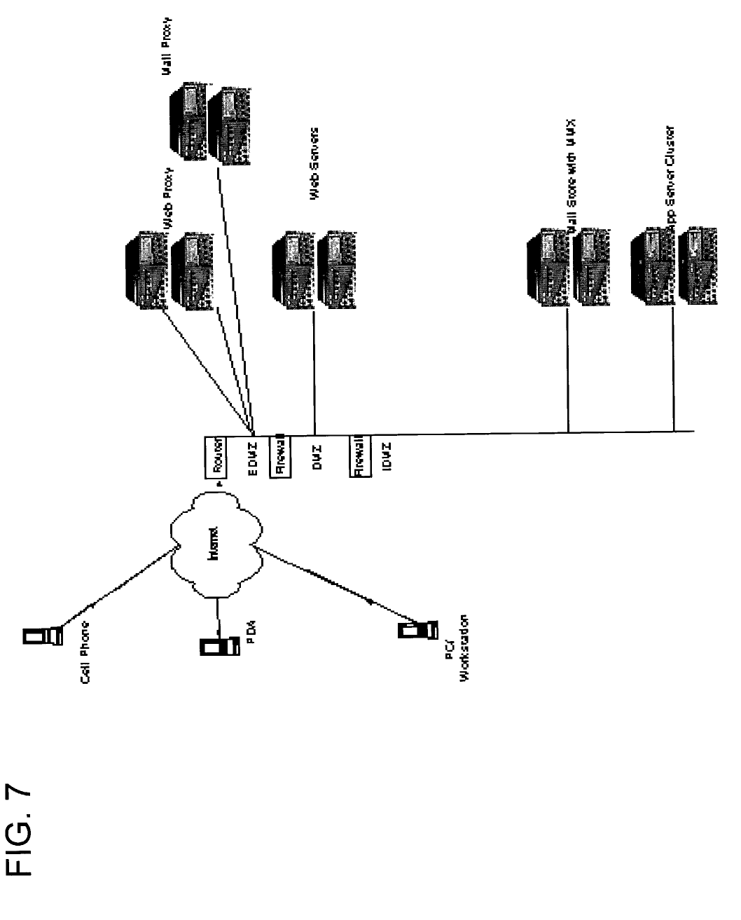

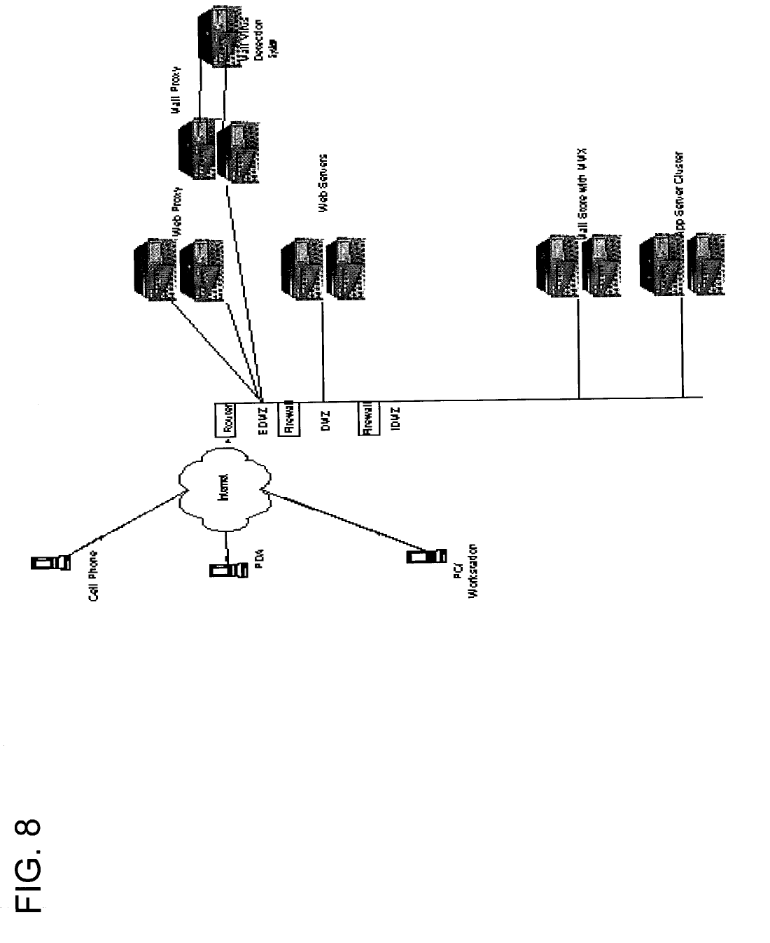

FIG. 7 shows a simple mail server with a mail proxy. In preferred embodiments, additional security techniques can be applied to the mail server implementation with a virus detection and a secure mail access protocol at the EDMZ as depicted in FIG. 8, which shows a mail server with a mail proxy (e.g., SMAP/Virus detection @ proxy). For example, this can help to ensure that virus does not infect the mail store or other mail attacks, in turn, ensuring that, in illustrative embodiments, the J2EE™ applications or the like environment is protected.

### Application & Security Server

In some embodiments, application servers may be employed since, e.g., such may play a significant role in much of today's dot-com environment. J2EE based application server platforms offer application level security via pre-defined protection domains, deployment descriptors, signed and encrypted components, and/or other techniques. In some instances, these application servers are deployed along with a security server, a server that hosts the security policies for one or more J2EE™ applications.

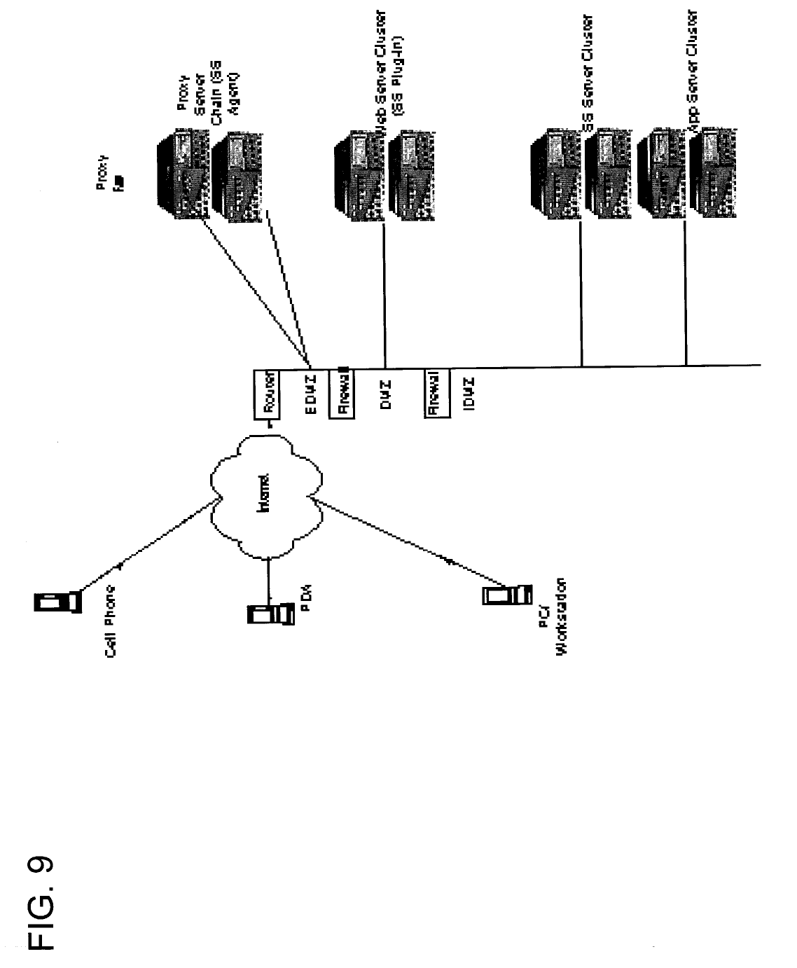

FIG. 9 shows an application server deployed in conjunction with a security server.

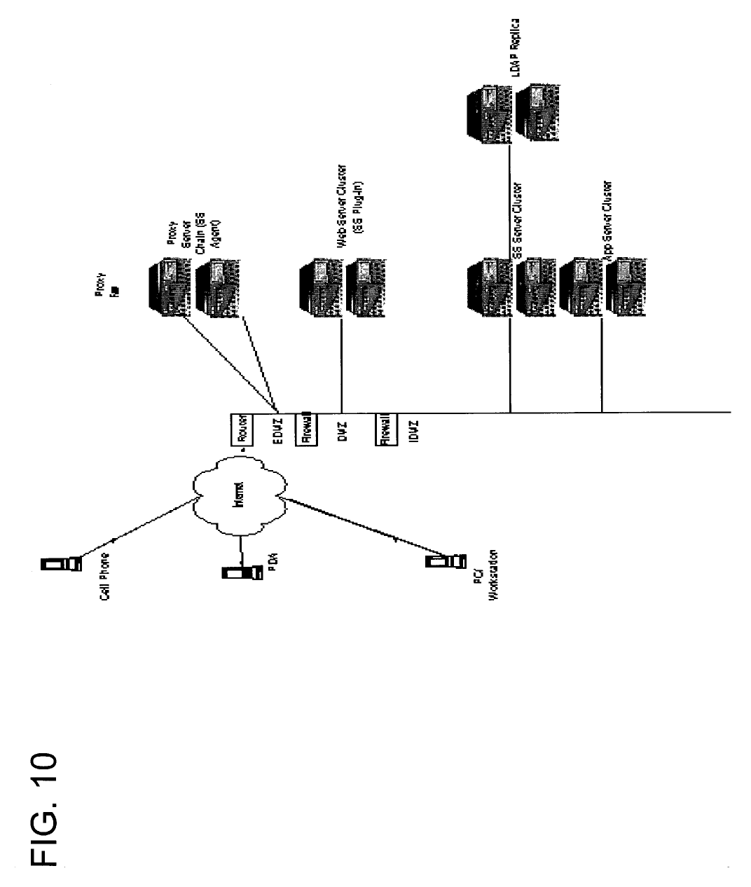

These security servers (e.g., Netegrity Site minder) can, for example in some cases, store certain security components in an LDAP server. These LDAP servers may be replica-instances of a master running locally on the security server or on dedicated LDAP replica servers in the DMZ, as depicted in FIG. 10, which shows an application server deployed in conjunction with a security server and LDAP.

The security server can work in conjunction with the application server to introduce the concept of permission and/or policy so as to enable the J2EE™ platform, for example, to offer fine-grain, highly configurable, flexible and/or extensible access control. This access control can be, e.g., specified for applets, servlets, JSP, java applications and/or EJB™ components, within and/or between different J2EE™ applications.

### Integration Servers (e.g., B2Bi and EAI Servers)

Due to the nature of the J2EE™ applications, for example, wherein they extend existing enterprise applications to the Internet, both B2B application integration (e.g., integration of 2 or more applications that run between enterprises) and Enterprise Application integration (e.g., integration of 2 or more applications that run between enterprises) play a key role. These integration servers may often support, for example, JTS, JMS and/or XML and in many cases CORBA. The deployment of these applications by themselves needs to be secure in order to ensure application level security measures are not jeopardized. B2B application integration products (e.g., web methods B2Bi server), may be deployed in, for instance, a number of scenarios. A first scenario is where the B2Bi proxy is located in the DMZ that also applies certain security measures and then forwards requests to the B2Bi server in the IDMZ.

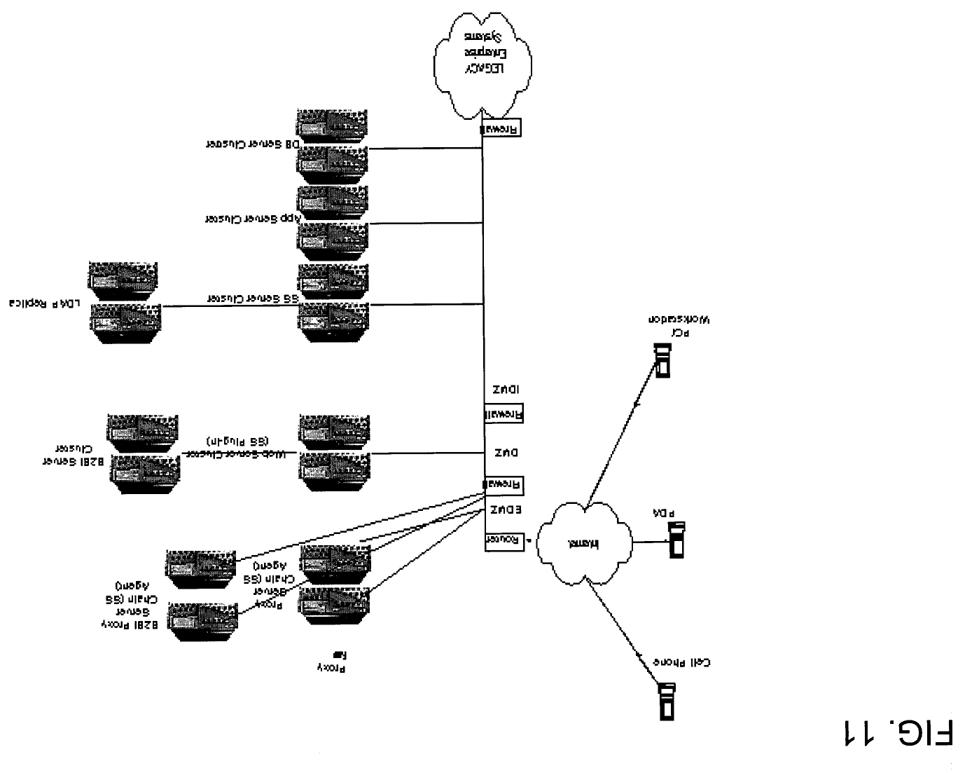

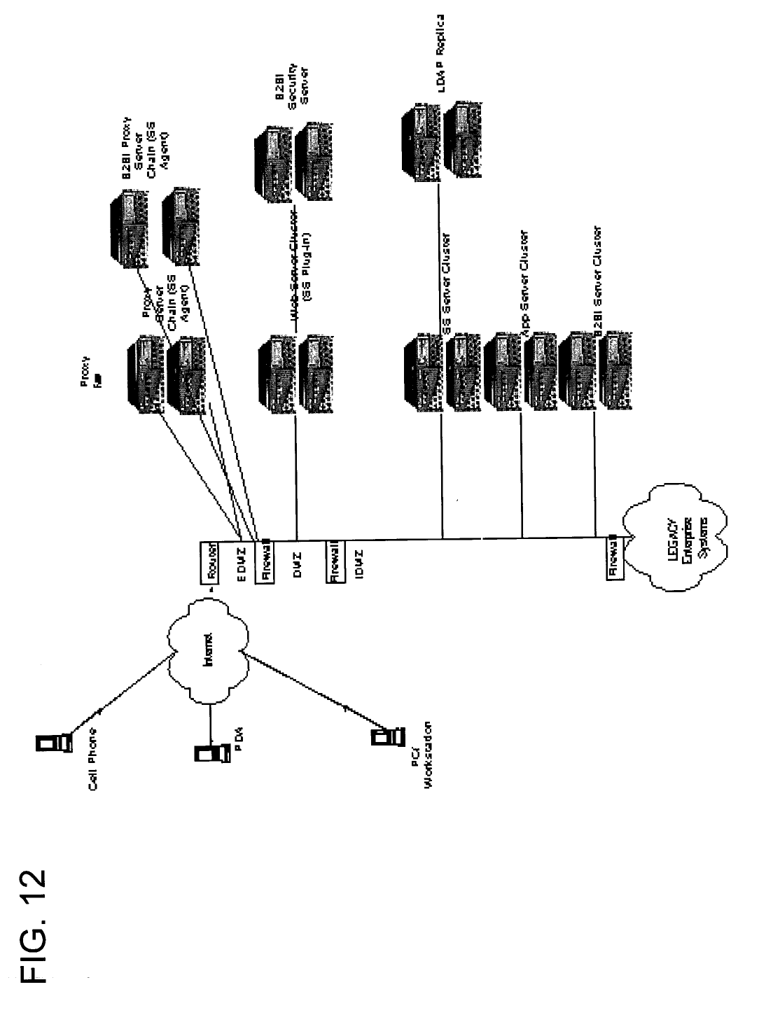

FIG. 11 shows an integration server (B2B) deployed in conjunction without a proxy. In some cases, where this type of deployment poses certain security threats, the B2Bi proxy can be implemented in the EDMZ with a B2Bi security server in the DMZ followed by a B2Bi server in the IDMZ. This is considered to be the safest deployment option. In certain cases, a B2Bi server may be deployed in the EDMZ where the B2B applications being integrated are not sensitive to security requirements. FIG. 12 shows an integration server (B2B) deployed in conjunction with a proxy.

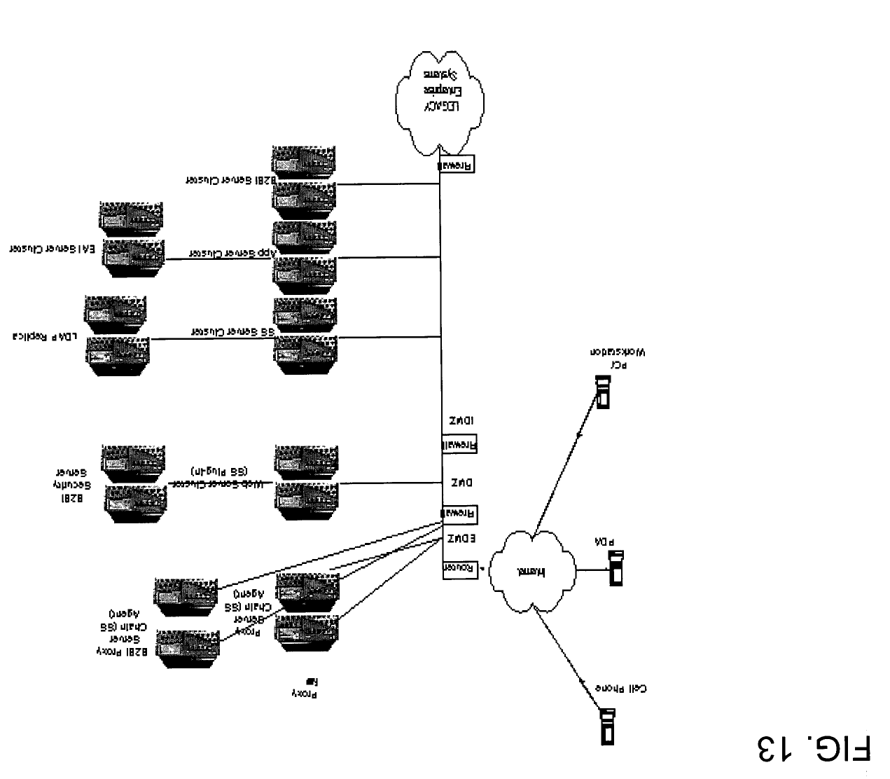

The B2Bi servers are facing outbound traffic to the Internet, whereas the EAI servers are facing outbound traffic towards the legacy environments, and therefore they typically get deployed along with the application servers in the IDMZ, without any touch points form the Internet, i.e., only the application servers running java beans are allowed to communicate to these integration servers and traffic flowing out of these servers can only traverse towards the legacy environment and not the firewalls protecting this environment form the internet. FIG. 13 shows integration server (EAI) deployment.

### Directory Server and Authentication Server (as Authentication & Authorization Server)

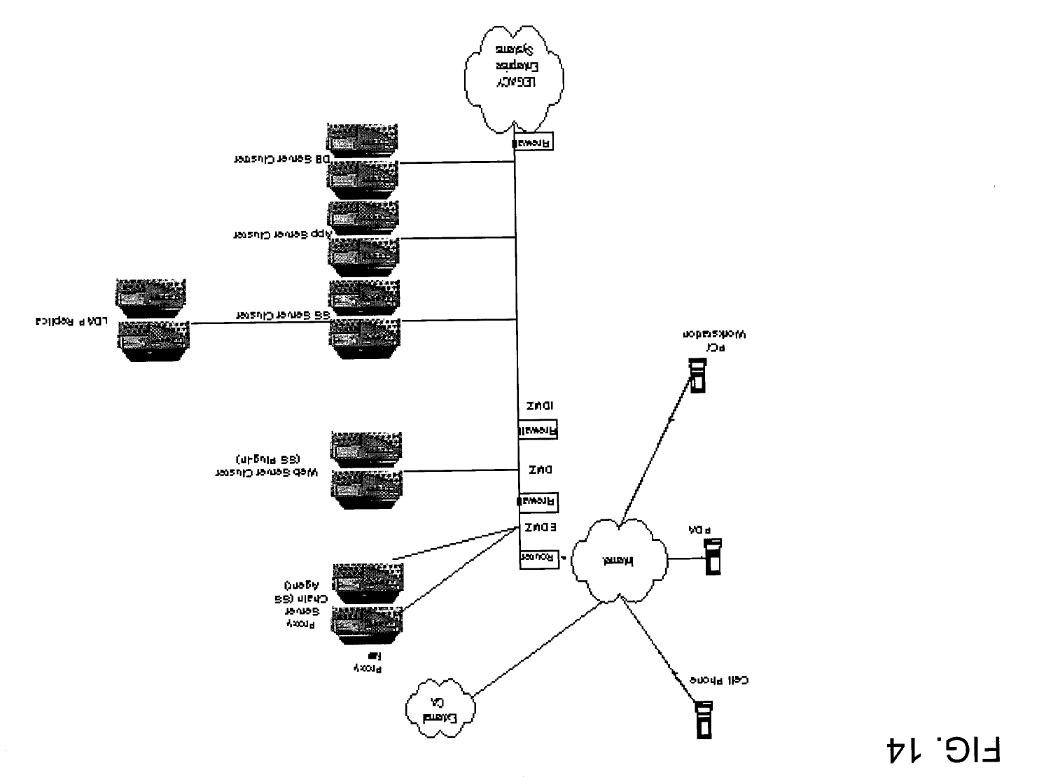

LDAP Servers typically store user-identifications, passwords and/or any common information shared by many applications. Further to the security server discussed above, there may also be security servers that perform just the role of authenticating users and providing them access to one or more applications (e.g., this does not cover what functionality can be accessed within an application via protection domains or between applications). These combinations of LDAP and security servers that are used to provide access to a network may be deployed in the IDMZ. In some instances, this security server could actually be the same server that is accessed by the application servers as a security policyholder. FIG. 14 shows a directory server deployment in conjunction with a security server.

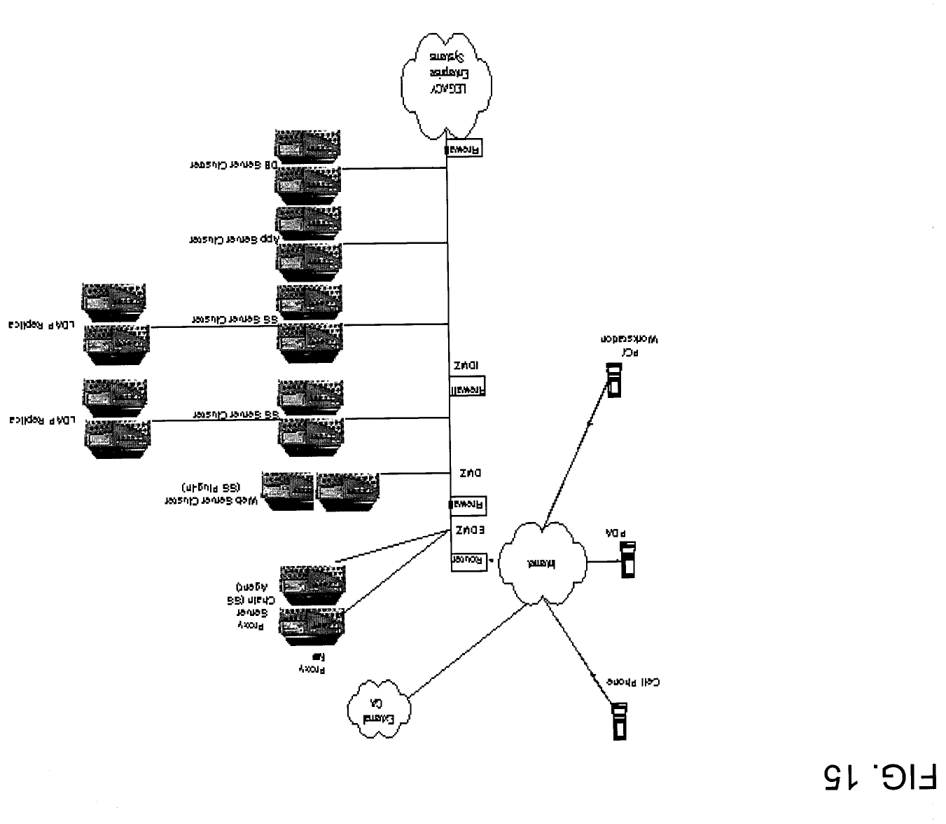

In many other, when warranted, scenarios this functional difference between the security server as an authentication and authorization server and a security policy holder might be isolated to its own dedicated servers in a different zone. The authentication and authorization server along with LDAP replicas with the required data in the DMZ and the security policy server with its required LDAP data in the IDMZ can be as depicted in FIG. 15, which shows a directory server alternate deployment in conjunction with a security server.

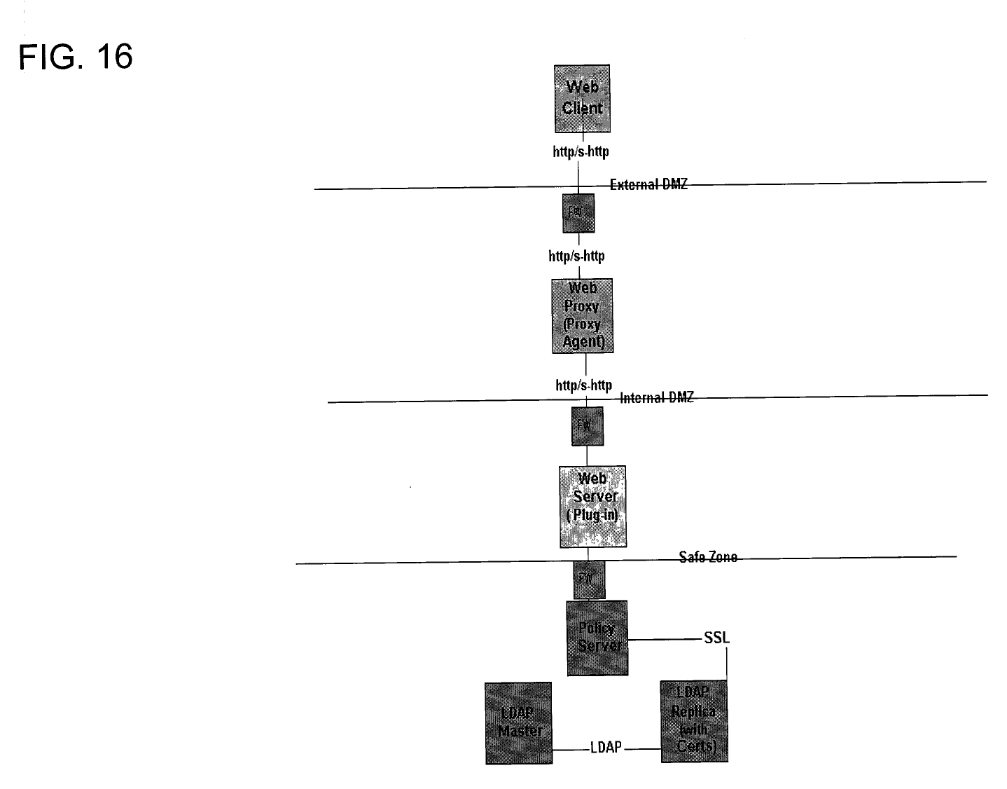

In some instances, the web proxy that accepts initial http connections establishes s-http connections with the client (e.g., after client and site certificate validation by a CA (certificate authority)) to accept user-ID and password. This user-ID and password (encrypted) may be passed by the web proxy-plug-in to the web-server security agent, back to the security server with SSO (single sign on) capability, that authenticates the user and authorizes access to a specific URL hosted by the web server (e.g., from where applications can be accessed). This approach may terminate user connection prior to reaching the IDMZ if authentication fails, while the prior scenario may not. Additionally, the workload may be distributed between the two security servers. FIG. 16 shows a logical connection flow diagram for security purposes.

### Messaging Server & Transaction Servers

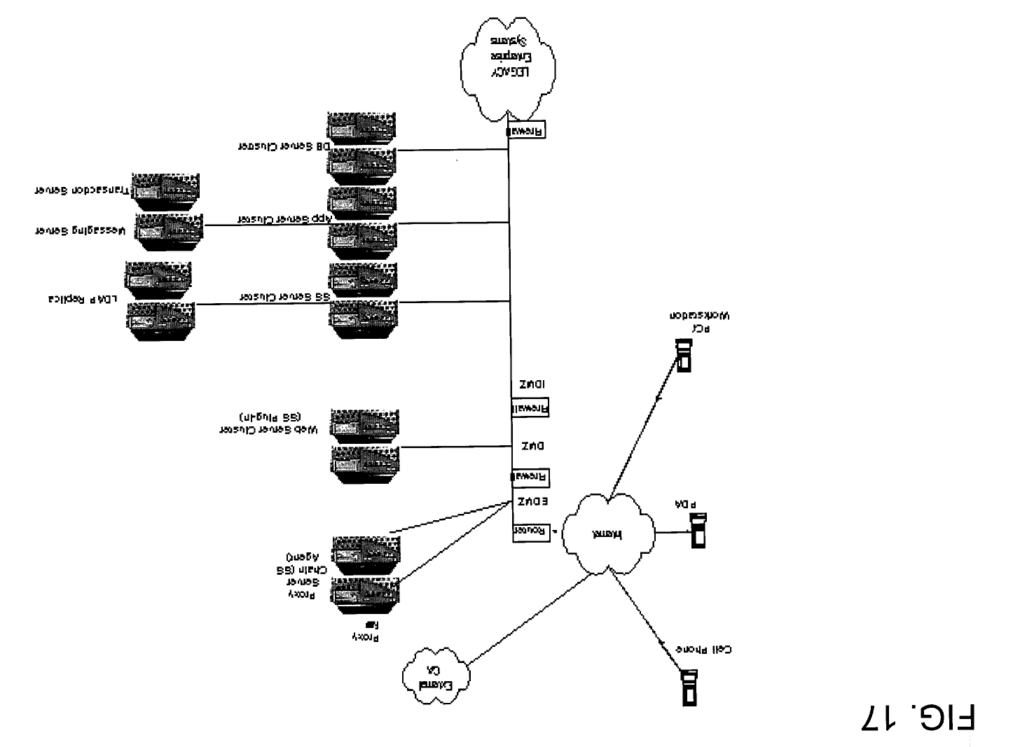

Similar to the EAI Servers, the messaging servers (e.g., JMS) and transaction servers (e.g., JTS) are typically accessed by the application servers in the IDMZ, and the out bound traffic from these application infrastructure solutions is flowing towards the firewall protecting the legacy environment as opposed to the firewalls protecting the J2EE™ or the like environment from the Internet. FIG. 17 shows a secure deployment of messaging server/transaction servers.

Therefore, these basic services are not accessed by any external touch points from the Internet and can only be accessed by the code running with the application server in the IDMZ. These nodes may be marked by the IDMZ firewalls so that any traffic originating from them are only flowing internally to, e.g., an enterprises back-end network. The legacy environment may have a receiving end in the form of a messaging gateway that accepts these requests and routes them to the appropriate enterprise application.

### CORBA & LDAP Gateways

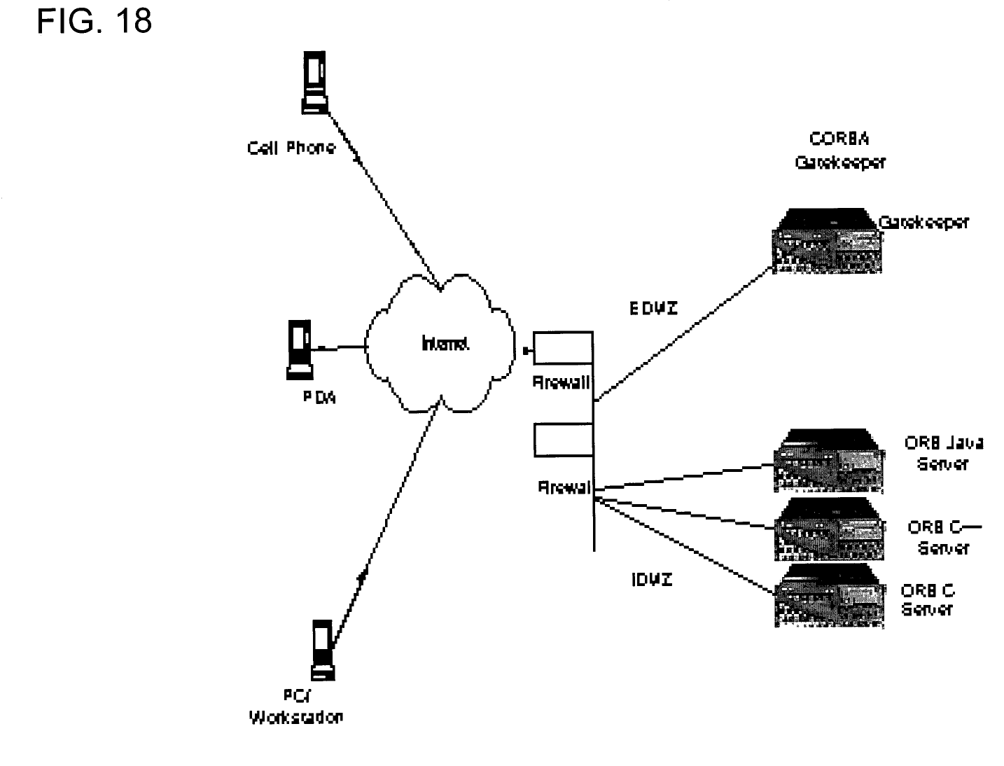

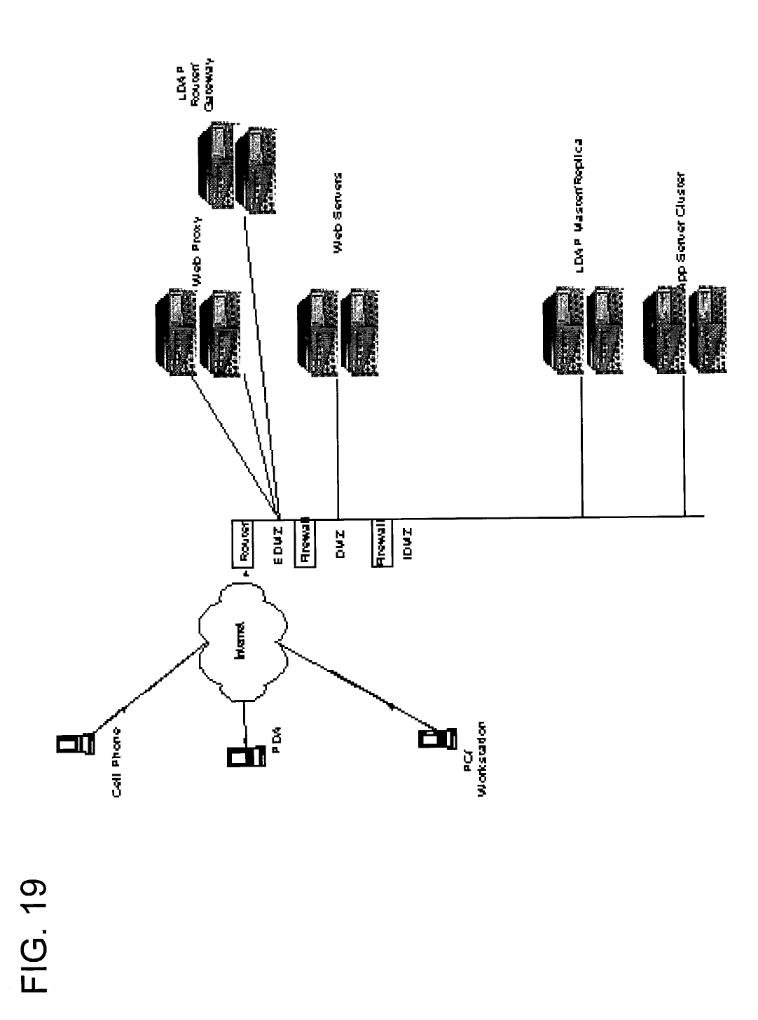

In certain cases, for instance, a CORBA server that is placed in a J2EE™ environment or the like that integrates with non-J2EE™ applications via JavaIDL (interface definition language) or the like might be doing so over the Internet or the like. In such cases, a CORBA gatekeeper may be deployed at the DMZ. FIG. 18 shows a secure deployment of CORBA servers. Similarly, in certain cases where two LDAP schemas are accessed by a J2EE™ application or the like and one is residing locally where the other might be residing in a different LAN or the like, and accessed over the Internet or the like, a LDAP gateway/router may be deployed in the DMZ. FIG. 19 shows a secure access to distributed LDAP data.

### Certificate Servers

A certificate management system (CMS), including, e.g., a primary certificate authority, a registration authority and a data recovery authority and, in some cases, a secondary certificate authority, may play a role in ensuring the identity of the user community, individual e-business site and/or their respective partner sites. Certificate servers may be important, for example, in some J2EE and XML or the like based applications, such as, e.g., used in financial systems. Component level security can be achieved via, e.g., digital signatures of Java and XML components. Application level security and intrusion detection can be achieved, e.g., via certified components and through that transaction integrity can be maintained. Typically, the certificate authority for J2EE applications or the like can be outsourced to certificate authorities, such as VERISIGN, ENTRUST, IDENTUS, etc.

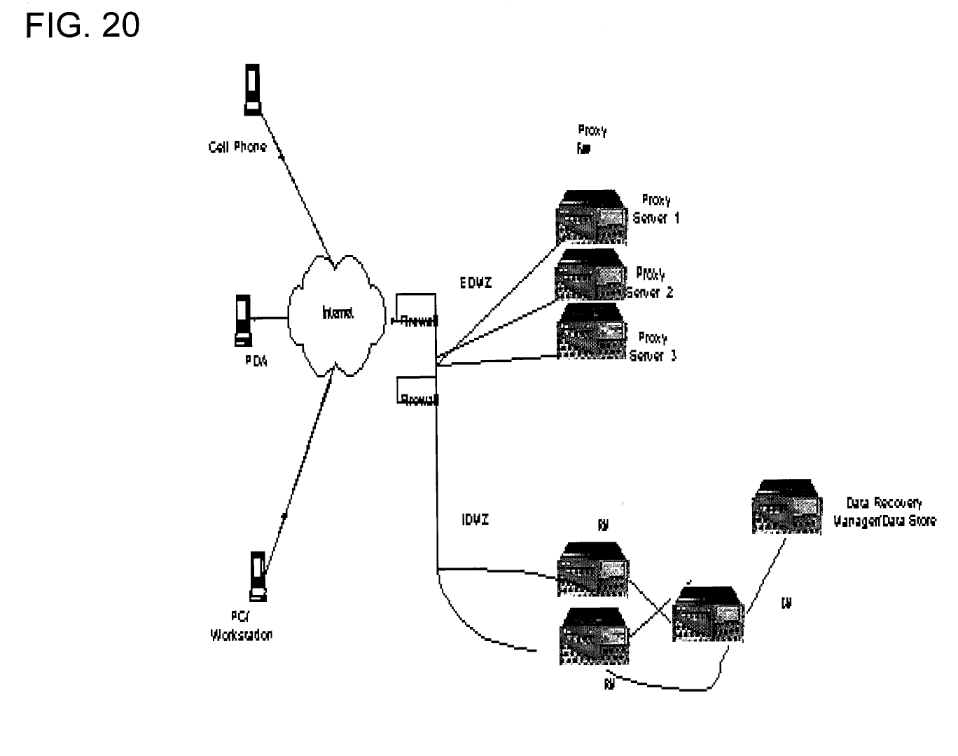

In some cases, where the CA may be hosted in the same environment as the J2EE™ application or the like, the certificate management server can be secured through a simple and successful approach of isolating sensitive data and restricting access to the same. The CMS can be functionally partitioned into a RM (registration manager), a CM (certificate manager) and a DM (data store/data recovery manager). FIG. 20 shows a secure deployment of CMS Servers.

The data manager can further be extended into DM-master and DM-replica. Through this approach, the master data store can be isolated to a highly secure zone and access to this data can be restricted to those nodes that act as the RM and CM. Even if the data from the DM master is replicated to replicas, the only source that can be manipulated or changed may be located in the safe zone. Some deployments of the CM, RM and DM may be in the safe zone. The firewall may be defined with a rule that states the specific nodes that access the DM and in some cases there could be a separate firewall between the CM and/or RM and the DM. FIG. 19 shows a secure deployment of CMS servers with additional firewall protection.

### Protocols Between Servers

Once all the application infrastructure solutions are identified for J2EE™ or the like technology architecture and their respective deployment within the network is solidified, the final item that is preferably accomplished is to identify particular protocols between the servers and the like. From one perspective, these servers are tuned to perform a specialized task in an efficient manner and, therefore, they tend to be called a DB server appliance, an LDAP server appliance, or the like, and so on. These boxes or appliances are preferably then locked up (e.g., by OS tightening and modification of network services) to talk only those protocols that are expected from the specified nodes. For example, if a B2Bi server is talking XML and accepts incoming connections from the app server and send outgoing connections to the B2Bi proxy server, then that is preferably all it can do.

### Broad Scope of the Invention

While illustrative embodiments of the invention have been described herein, it will be appreciated that the present invention is not limited to the various embodiments described herein, but includes any and all embodiments having modifications, omissions, combinations (e.g., of aspects across various embodiments), adaptations and/or alterations as would be appreciated by those in the art based on the present disclosure. The appended claims are to be interpreted broadly based the language employed in the claims and not improperly limited to illustrative examples described in the present specification or in the prosecution of the application. As merely one example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts are not recited in support of that function.

What is claimed is:

1. A system for providing secure access via a public network for at least one client computer to a local network having a legacy system, comprising:
a) a client computer in communication with a public network;
b) an access service zone operating as a touch point for communication with the client computer;
c) a network identity service zone providing network security techniques for securing communications with the client computer;
d) a first firewall between the access service zone and the network identity service zone;
e) a second firewall between the network identity service zone and network application zone;
whereby secure access to the network application zone can be provided to a user at the client computer.

2. The system of claim 1, wherein said access service zone includes at least one server that is configured to communicate only with said network identity service zone.

3. The system of claim 2, wherein the at least one server is configured to remain unaware of whether security techniques are to be applied.

4. The computer system of claim 1, wherein said access service zone includes a reverse proxy gateway server or a portal web server.

5. The system of claim 1, wherein said network identity service zone includes at least one server that provides at least one of the following security techniques: authentication, authorization, virus checking, spam control, intrusion detection, certification/validation of identity.

6. The system of claim 1, wherein said public network is the Internet.

7. A computer system for providing secure access via a public network for at least one client computer to a local system, comprising:
a) a first tier system configured for network access services;
b) a second tier system configured for network identity services; and
c) a third tier system configured for network application services.

8. The computer system of claim 7, wherein said first tier system includes a reverse proxy gateway server or a portal web server.

9. A computer system for providing secure access via a public network for at least one client computer to a local system, comprising:
a) access means for providing network access alone to an external client computer at a first tier system;
b) identity means for providing all network identity services at a second tier system; and
c) services means for providing network application services at a third tier system.

10. The computer system of claim 9, further including means for aligning application infrastructure with application techniques used within the second tier system.

11. The computer system of claim 9, wherein said access means includes a reverse proxy gateway server or a portal web server.

12. A method for creating a secure system providing services from within a private system to at least one client computer via a public network, comprising:
a) establishing a predetermined set of application infrastructure corresponding to application security techniques;
b) selecting application security techniques within said set; and
c) driving corresponding application infrastructure based on said selected application security techniques in accordance with the established set.

13. The method of claim 12, further including providing said security techniques as J2EE security techniques.

14. The method of claim 12, wherein said act of driving corresponding application infrastructure includes deploying a touch point server including a reverse proxy web server, a portal gateway server and/or another server configured to act as a touch point.

15. The method of claim 14, further including locating said touch point server in a first tier system that is separated from a second tier system that provides all network identity services.

16. The method of claim 15, further including separating said second tier system from a third tier system that provides network application services.
